(19) United States
(12) Patent Application Publication
(10) Pub. No.: US 2012/0198960 A1
(43) Pub. Date: Aug. 9, 2012

(54) HIGH ENERGY DENSITY FLYWHEEL

(76) Inventors: Maxime R. Dubois, Levis (CA); Michael Desjardins, Quebec (CA); Louis Tremblay, Quebec (CA); Jean Ruel, Quebec (CA)

(21) Appl. No.: 13/323,202

(22) Filed: Dec. 12, 2011

Related U.S. Application Data
(63) Continuation-in-part of application No. PCT/CA2010/000921, filed on Jun. 15, 2010.
Application No. PCT/CA2010/000921 is a continuation-in-part of application No. PCT/CA2010/000922, filed on Jun. 15, 2010.
(60) Provisional application No. 61/187,176, filed on Jun. 15, 2009.
(60) Provisional application No. 61/233,664, filed on Aug. 13, 2009.
(60) Provisional application No. 61/187,170, filed on Jun. 15, 2009.
(60) Provisional application No. 61/187,174, filed on Jun. 15, 2009.
(60) Provisional application No. 61/187,176, filed on Jun. 15, 2009.
(60) Provisional application No. 61/233,664, filed on Aug. 13, 2009.

(51) Int. Cl. H02K 7/02

(52) U.S. Cl. 74/572.12; 74/572.11

(57) ABSTRACT

A high energy density flywheel has a central rotating axle for storing kinetic energy. The flywheel comprises a first member to be operatively mounted around the axle. The first member comprises a first material having a given high mass density enabling a given high kinetic energy storage capacity. The flywheel comprises a second member operatively attached to the first member. The second member surrounds an outside portion of the first member subject to radial forces generated by a rotation of the flywheel. The second member comprises a second material having a given high yield strength enabling a given high maximum rotational speed. The second member enables an operation of the flywheel at a given high flywheel rotational speed greater than the rotational speed that would be allowed by the maximal yield strength of the first material, to thereby provide the flywheel with a given high kinetic energy storage capacity.

### CROSS REFERENCE TO MATED APPLICATIONS

This application claims priority of US Patent Application having Ser. No. 61/187,176 which was flied on Jun. 15, 2009 and entitled “HIGH POWER DENSITY FLYWHEEL”, the specification of which is hereby incorporated by reference.

This application also claims priority of US Patent Application having Ser. No. 61/233,664 which was filed on Aug. 13, 2009 and entitled “ENERGY STORAGE SYSTEM AND METHOD”, the specification of which is hereby incorporated by reference.

The present application also relates to PCT Application entitled “ENERGY STORAGE SYSTEM AND METHOD”, the specification of which is incorporated herein by reference.

### FIELD OF THE INVENTION

The invention relates to high energy flywheel energy storage systems for medium and long term energy storage. More particularly, the invention relates to a high energy density flywheel for use in flywheel energy storage systems, that enables to combine a high density of energy storage and a high rotational speed while minimizing power losses, thereby maximizing the energy storage duration.

### BACKGROUND OF THE INVENTION

Flywheel energy storage systems are generally known to supply high power during a short period of time. They are reliable and can be maintained at a low cost. For example, a typical flywheel may provide over 20 years of operational life without, requiring expensive maintenance.

In the art, a flywheel energy storage system is typically composed of five principal modules which are a containment vessel, a motor-generator, a set of bearings, a rotating shaft and a rotating disc.

The containment vessel is used to protect users from breakage of the rotating disc that may be subject to be expelled from the rotating shaft on which it is mounted. The containment vessel is also used to minimize the air friction on the rotating disc in using a vacuum pump to extract most of the air inside the containment vessel.

The motor-generator enables the electro-mechanical conversion from electric energy to kinetic energy and vice versa.

The bearings are used to conveniently support the rotating shaft and the rotating disc. The rotating disc, also called a wheel or a flywheel, is used to store kinetic energy (E) therein according to the weight (M) of the disc, the square of the radius (R) of the disc and the square of the rotating speed (ω) of the disc.

In order to store as much energy as possible, although it would be desirable to use a rotating disc of a great radius composed of a heavy material and rotating as fast as possible, the disc of the flywheel has nevertheless to be designed according to the peripheral speed limit of the material that composes the rotating disc. This peripheral speed limit is proportional to the rotating speed and the radius of the disc.

This peripheral speed limit is reached when the tangential pressure on the peripheral of the rotating disc reaches the maximal yield strength , which may also be called the maximal yield stress or the maximal elastic constrain of the material of the rotating disc. Over that limit the disc is subject to permanent deformation and breakages may occur, which is highly undesirable.

The maximal yield strength is not the same for each material. For instance, the maximal yield strength of iron is lower (about 550 MPa) than the one of carbon (about 3 447 MPa), thereby justifying the use of carbon or other similar material for high speed applications.

Typically, two configurations are used in flywheel energy storage system applications. The first configuration uses heavy material such as iron with a great radius for low speed applications while the second configuration uses light material such as composite material with short radius for high speed applications. Indeed, composite material have a high yield strength which enable a high rotational speed much greater than the rotational speed allowed by the maximal yield strength of a heavier material.

The determination of the material used for the composition of the disc, its weight, its radius and its rotating speed are chosen according to the losses found in the different parts of the flywheel and of the flywheel storage system.

More particularly, in a typical flywheel storage system, there are four types of losses: aerodynamics, electrics, magnetics and by friction. The latest are caused by the friction between two pieces, such as between mechanical bearings and the rotating shaft. They are proportional to the rotating disc weight and to the square of the rotating speed. The magnetic losses are produced by the variation of the magnetic induction in ferromagnetic material and they are proportional to the square of the rotating speed of the disk. They can be found in the motor-generator or in the magnetic bearings. The electric losses or copper losses are found in the copper coil of the motor-generator or in the magnetic bearings. Finally, aerodynamic losses are essentially the losses due to the friction of the rotating parts of the flywheel with the air in the containment vessel.

Minimizing those losses is not easy to achieve since they are all interrelated. For instance, the reduction of friction losses may be achieved with magnetic bearings instead of mechanical bearings, but that particular embodiment will increase the magnetic and electric losses of the whole system, That embodiment will also increase the cost of the energy storage system but will nevertheless be preferred in some cases for improving the storage duration.

Using a high rotational speed may be desirable to store more kinetic energy but it will also increase the overall losses of the whole energy storage system, i.e. the magnetic losses in the motor-generator and magnetic bearings, the losses caused by friction in the mechanical bearings and the aerodynamic losses.

It would therefore be desirable to provide an improved flywheel that will enable a given high energy density storage over a long term while minimizing the energetic losses.

### BRIEF SUMMARY

Accordingly, there is disclosed a high energy density flywheel having a central rotating axle for storing kinetic energy. The high energy density flywheel comprises a first member to be operatively mounted around the central rotating axle, the first member comprising a first material having a given high mass density enabling a given high kinetic energy storage capacity. The high energy density flywheel also comprises a second member operatively attached to the first member, the second member surrounding an outside portion of the first member subject to radial forces generated by a rotation of the flywheel. The second member comprises a second material having a given high yield strength enabling a given high maximum rotational speed. The second member enables an operation of the high energy density flywheel at a given high flywheel rotational speed, to thereby provide the flywheel with a given high kinetic energy storage capacity.

The high energy density flywheel enables to store a great quantity of kinetic energy while minimizing the energetic losses therein and improving the storage duration of the stored kinetic energy, which is of great advantage.

The high energy density flywheel may provide high efficiency energy storage, particularly for medium and long term energy storage applications ranging from several hours to 24 hours for example, which is of great advantage.

In one embodiment, the given high flywheel rotational speed is greater than the rotational speed which would be allowed by the yield strength of the first material alone.

In one embodiment, the high energy density flywheel is adapted to be mountable on a rotating shaft.

In another embodiment, the high energy density flywheel further comprises a magnetic coupling element mounted on an inner side thereof and adapted for interacting with an associated magnetic driving element mountable proximate the central rotating axle.

In a further embodiment, the high energy density flywheel further comprises an inner hub fixedly mounted to the rotating shaft via a first coupling and a second coupling Mounted on both sides of the inner hub.

In one embodiment, the first member has a crown shape and is made of a single piece.

In one embodiment, the first material is selected from a group consisting of steel, lead, tungsten and a combination thereof.

In another embodiment, the second material is selected from a group consisting of carbon, Kevlar™ and a combination thereof.

In still another embodiment, the second material comprises a composite material.

In one embodiment, the high energy density flywheel further comprises attaching means for attaching the first member and the second member together. In a further embodiment, the attaching means comprise glue.

In one embodiment, the second member wholly encloses the first member.

In another embodiment, the second member is belt shaped and extends on a radial outside portion of the first member.

In one embodiment, the first member comprises a plurality of sub-elements, each being enclosed in the second member.

In one embodiment, the second member is integral.

In one embodiment, the first member has a weight evenly distributed around the central rotating axle.

In one embodiment, the given high yield strength of the second material is greater than a yield strength of the first material.

In another embodiment, the first member has a toroidal shape.

In a further embodiment, the second member has an empty toroidal shape wholly enclosing the first member.

In still a further embodiment, the second member comprises at least three covers, each being wound on the first member.

In one embodiment, each of the three covers is wound on the first member according to a respective principal direction thereof.

In one embodiment, a first one of the three covers is axially wound on the first member, a second one of the three covers is circumferentially wound on the first member and a third one of the three covers is wound at 45 degrees with respect to the first one of the three covers.

In one embodiment, the given high maximum rotational speed ranges from 4000 rpm to 12000 rpm.

In another embodiment, the high energy density flywheel further comprises a vacuum containment vessel for enclosing the high energy density flywheel therein.

In one embodiment, the high energy density flywheel further comprises superconducting magnetic bearings for supporting the flywheel.

According to another embodiment, there is disclosed a high energy density flywheel to be mounted on a rotating shaft for storing kinetic energy. The high energy density flywheel comprises a first member to be operatively mounted on the rotating shaft, the first member comprising a first material having a given high mass density enabling a given high kinetic energy storage capacity and a given low yield strength enabling a given low maximum rotational speed. The high energy density flywheel also comprises a second member surrounding an outside portion of the first member subject to radial forces generated by a rotation of the flywheel. The second member comprises a second material having a given low mass density enabling a given low kinetic energy storage capacity and a given high yield strength greater than the given low yield strength of the first member enabling a given high maximum rotational speed. The second member enables an operation of the high energy density flywheel at a given flywheel rotational speed greater than the given low maximum rotational speed permitted by the given low yield strength of the first material, to thereby provide the flywheel with a given high kinetic energy storage capacity.

According to another aspect, there is also disclosed the use of the high energy density flywheel as previously defined, for storing the kinetic energy over a 24 hours period.

According to another aspect, there is also disclosed the use of the high energy density flywheel as previously defined, for storing the kinetic energy during a plurality of hours.

According to another aspect, there is also disclosed the use of the high energy density flywheel as previously defined, in combination with a power converter and a motor-generator for enabling a bidirectional conversion of the kinetic energy into electric energy.

According to still another aspect, there is also disclosed the use of the high energy density flywheel as previously defined, in combination with an electrical network for stabilizing fluctuation of the network.

According to yet another aspect, there is also disclosed the use of the high energy density flywheel as previously defined, in combination with a flywheel energy storage system for recharging an electrical battery in a given period of time.

In one embodiment, the recharged electrical battery is a vehicle electrical battery.

In a further embodiment, the given period of time ranges from 1 minute to 10 minutes.

According to yet another aspect, there is also disclosed the use of the high energy density flywheel as previously defined, in combination with an electrical network for providing a UPS.

According to yet another aspect, there is also disclosed the use of the high energy density flywheel as previously defined, in combination with an electrical network for enabling renewable energy integration with the electrical network.

According to another aspect, there is also provided a flywheel energy storage system using such a high energy density flywheel.

The flywheel energy storage system may provide high efficiency energy storage, particularly for medium and long term energy storage applications, which is of great advantage.

### BRIEF DESCRIPTION OF THE DRAWINGS

In order that the invention may be readily understood, embodiments of the invention are illustrated by way of example in the accompanying drawings.

FIG. 1 shows a typical flywheel energy storage system.

FIG. 2 is a table showing characteristics of different types of flywheel.

FIG. 3A is a longitudinal cross sectional view of a high energy density flywheel, according to one embodiment.

FIG. 3B is another cross sectional view of the high energy density flywheel shown in FIG. 3A, taken along line B-B.

FIG. 4 is a longitudinal cross sectional view of another high energy density flywheel.

FIG. 5 is a longitudinal cross sectional view of another high energy density flywheel.

FIG. 6 is a longitudinal crass sectional view of another high energy density flywheel.

FIG. 7 is a longitudinal cross sectional view of another high energy density flywheel.

FIG. 8 is a longitudinal cross sectional view of another high energy density flywheel.

FIG. 9A is a longitudinal cross sectional view of another high energy density flywheel.

FIG. 9B is a top view of the high energy density flywheel shown in FIG. 9A.

FIG. 10 is a longitudinal cross sectional view of another high energy density flywheel.

FIG. 11 illustrates an embodiment of a manufacturing processing step used for manufacturing the high energy density flywheel of FIG. 10_{—}

FIG. 12 is a table illustrating the mechanical characteristics of two different materials.

FIG. 13 and FIG. 14 are tables illustrating the energy which may be store in a high energy density flywheel for various configurations thereof.

FIG. 15 is a table showing the volumetric energy density and the rotational speed of a flywheel for various configurations thereof.

Further details of the invention and its advantages will be apparent from the detailed description included below.

### DETAILED DESCRIPTION

In the following description of the embodiments, references to the accompanying drawings are by way of illustration of examples by which the invention may be practiced. It will be understood that other embodiments may be made without departing from the scope of the invention disclosed.

Throughout the following description, various embodiments of a high energy density flywheel will be described. The skilled addressee will appreciate upon reading of the detailed description that these embodiments of a high energy density flywheel enable to store a great quantity of kinetic energy while minimizing the energetic losses therein and improving the storage duration of the stored kinetic energy.

As it will become apparent below, the high energy density flywheel may provide high efficiency energy storage, particularly for medium and long term energy storage applications ranging from several hours to 24 hours. The skilled addressee will nevertheless appreciate that the high energy density flywheel may also be used in various other applications, including short term energy storage applications.

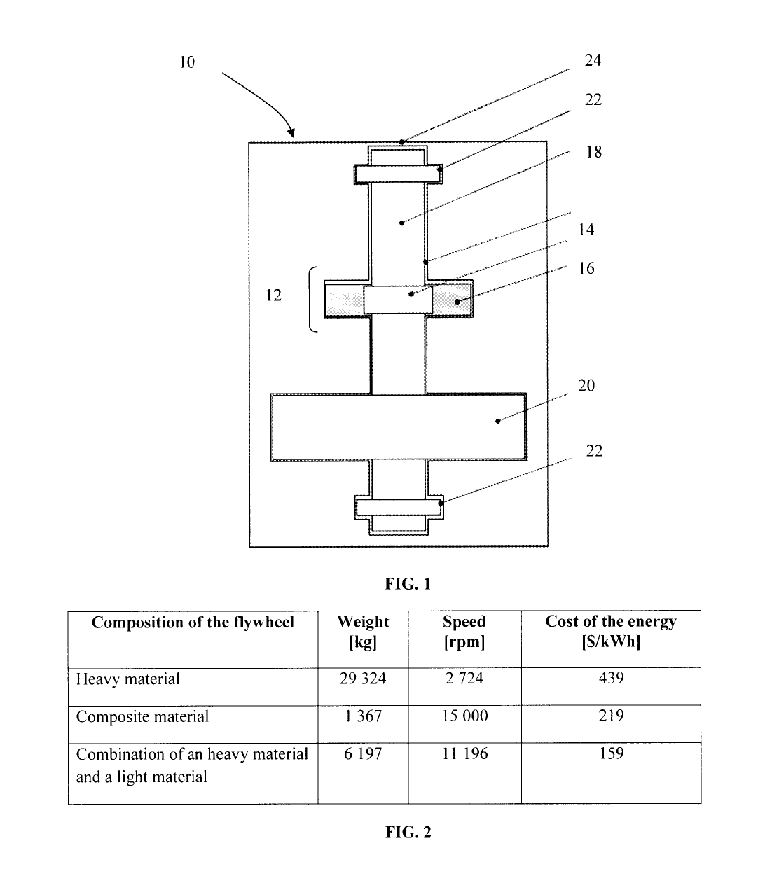

Referring to FIG. 1, the general principle of an energy storage system using a flywheel will be described according to one embodiment.

The energy storage system 10 comprises a motor-generator 12 comprising a rotor 14 and a stator 16 for enabling the electro-mechanical conversion from electric energy to kinetic energy and vice versa, as well known in the art. The energy storage system 10 comprises a rotating shaft 18 operatively connected to the motor-generator 12 and driven by the rotation of the rotor 14 of the motor-generator 12. The energy storage system 10 also comprises a flywheel 20 operatively connected to the shaft 18 and driven by the rotation thereof. Bearings 22 are used to conveniently support the rotating shaft 18 and the rotating flywheel 20.

The illustrated energy storage system 10 also comprises a containment vessel 24 enclosing the system 10 which is devised to protect users from breakage of the flywheel 20 that may be subject to be expelled from the rotating shaft 18 on which it is mounted. The containment vessel 24 may also be used to minimize the air friction on the flywheel 20 in using a vacuum pump (not shown) to extract most of the air inside the containment vessel 24, as known in the art.

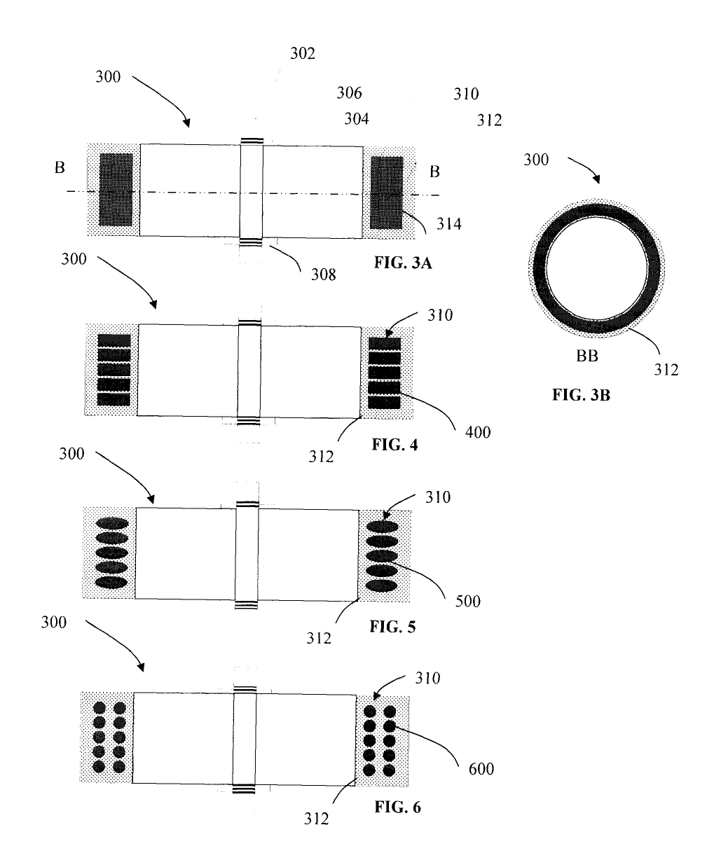

Referring to FIG. 3A and FIG. 3B, there is shown a high energy density flywheel 300 for storing kinetic energy according to one embodiment. In the illustrated embodiment and as previously mentioned, the high energy density flywheel 300 has a central rotating axle and is devised to be mounted on a rotating shaft 302 driven by a motor-generator (not shown) for storing kinetic energy therein.

In the illustrated embodiment, the high energy density flywheel 300 comprises an inner hub 304 fixedly mounted to the rotating shaft 302 via a first coupling 306 and a second coupling 308.

The high energy density flywheel 300 comprises a first member 310 to be operatively mounted around the central rotating axle. In the illustrated embodiment, the first member 310 is operatively attached to the inner hub 304 via a second member 312, The first member 310 is integral and has a crown shape, as better shown in FIG. 3B.

The first member 310 comprises a first material having a given high mass density enabling a given high kinetic energy storage capacity. In one embodiment, the first material may be selected from a group consisting of steel, lead, tungsten and any combination thereof presenting the characteristics mentioned above. The skilled addressee will appreciate that any other material or composition of material providing a suitable high mass density may be considered.

In a further embodiment, the first material also has a given low yield strength, also called elastic constraint, enabling a given low maximum rotational speed.

The high energy density flywheel 300 also comprises a second member 312 operatively attached to the first member 310 and surrounding an outside portion 314 of the first member 310 subject to radial forces generated by a rotation of the flywheel 300.

In the illustrated case, the second member 312 is fixedly attached to the inner hub 304 and encloses totally the first member 310. Glue or any other suitable fastener or attaching means may be used to fixedly attach the second member 312, the inner tube 304 and the first member 310 together.

The second member 312 comprises a second material having a given high yield strength, also called elastic constraint, greater than the low yield strength of the first member 310 enabling a given high maximum rotational speed. In one embodiment, the second material may be selected from a group consisting of carbon, Kevlar™ and any composite material presenting the characteristics mentioned above. A combination of different types of such material may also be considered in an alternative embodiment. The skilled addressee will appreciate that any other material or composition of material providing a suitable high yield strength may be considered.

In one embodiment, the second member 312 also has a given low mass density enabling a low kinetic energy storage capacity.

The second member 312 enables an operation of the high energy density flywheel 300 at a given high flywheel rotational speed, to thereby provide the flywheel with a given high kinetic energy storage capacity.

The skilled addressee will appreciate that this embodiment enables to combine the advantages of each type of a single material flywheel, which is of great advantage. Indeed, the above described flywheel enables a high energy storage capacity in the first member 310, thanks to its particular properties described above, while allowing a higher rotational speed than the one permitted in the case where no second member 312 is used, as it will more clearly detailed thereinafter.

In the illustrated embodiment, the second member 312 totally encloses the first member 310 but the skilled addressee will appreciate that various other arrangements may be considered. For example, the second member 312 may only extend on the outside radial portion 314 of the first member 310 subject to radial forces generated by a rotation of the flywheel 300, like a radial belt. In another embodiment, the first member 310 may be in direct contact with the inner hub 304. In still another embodiment, the flywheel 300 may be provided without the inner hub 304 and the first element 310 may be directly attached to the shaft 302. In yet another embodiment which is not illustrated, a magnetic coupling element may be mounted on an inner side of the flywheel, the coupling element being adapted for interacting with an associated magnetic driving element mountable proximate the central rotating axle.

The skilled addressee will nevertheless appreciate that, in one embodiment, it is advantageous to mount the heavy weight away of the rotating shaft 302 to maximize the energy storage capacity.

Now referring to FIGS. 4 to 6, in one embodiment, the first member 310 may comprise a plurality of sub-elements of the first material, each sub-element being enclosed into the second member 312. In FIG. 4, five similar sub-elements 400 having a crown shape and a rectangular cross section are embedded in the second member 312, the second member 312 being integral. In FIG. 5, five similar sub-elements 500 having a crown shape are still used but they have an ovoid cross section. In FIG. 6, two sets of five sub-elements 600 having a crown shape and a circular cross section are used. The crown shape of the sub-elements of the first set has a first diameter while the crown shape of the sub-elements of the second set has a second diameter.

The skilled addressee will appreciate that in one embodiment, the first member 310 may be embodied in the second member 312 in a discrete manner.

The skilled addressee will also appreciate that in one embodiment, the weight of the first member is equally distributed around the shaft 302. This equally distributed weight may contribute to the stability of the flywheel 300 when in rotation, particularly at a high speed, which is of great advantage. This distributed weight may also help minimizing the friction between the shaft 302 and the supporting bearings (not shown) in order to minimize the overall losses of an energy storage system. Moreover, it may also help reducing the weight of the overall energy storage system since the bearings will not have to be over-sized.

To further minimize the overall losses, in one embodiment, superconducting magnetic bearings may be used.

In each of the above described illustrated embodiments, the second member 312 is integral but the skilled addressee will appreciate that other arrangements may be considered. Moreover, the second member 312 may have a rectangular cross sectional shape but other shapes such a rounded shape or a tapered shape may be considered. It may also be considered to provide the second member 312 with thicker portions where the constraints are more important.

As it will be more clearly explained below, in one embodiment, the given high maximum rotational speed ranges from 4000 rpm to 12000 rpm but other values may be selected, as it will become apparent thereinafter.

In one embodiment, the high energy density flywheel further comprises a vacuum containment vessel for enclosing the high energy density flywheel therein, as detailed above.

Referring now to FIG. 2, different types of flywheel may be compared according to the actual cost of the energy stored. A theoretical simulation has been made for a flywheel enabling a 200 kWh energy storage capacity, a height of one meter and a radius of 0.75 meter. The maximal authorized speed has been limited to 15 000 rpm in order to limit the losses due to the magnetic bearings of the overall energy storage system used. From the table shown in FIG. 2, it can be shown that a flywheel made of a composite material provides a better energy cost compared to a flywheel made of a heavy material. The table also shows that a high energy density flywheel made of a first heavy material and of a second light material enclosing the first material according to the invention provides greater results than any of the two other types of flywheel.

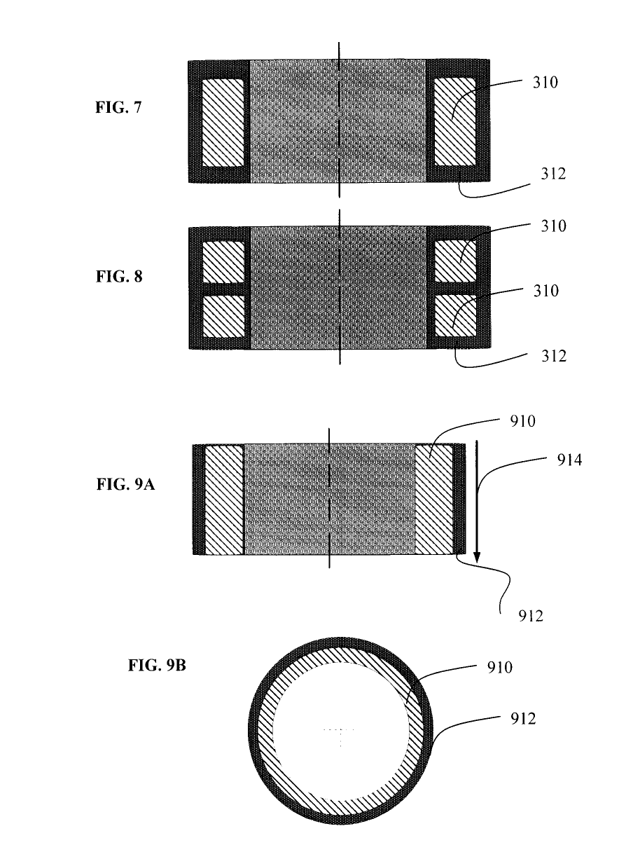

FIGS. 7 to 9 show other embodiments illustrating various configurations for the first member 310 and the second member 312.

Referring now to FIG. 9A and FIG. 9B and also to FIGS. 11 to 13, a finite element analysis will be presented for an embodiment of a high energy density flywheel as illustrated in FIG. 9A and 9B, that is an annular disk 910 acting as the first member, surrounded by an outer annular belt 912, acting as the second member.

The annular disk 910 used has an inner diameter of 1,425 meter and an outer diameter of 1,900 meter. The skilled addressee will appreciate that the thickness of the outer annular belt 912 may be varied.

As previously described, the outer annular belt 912 is made of a composite material having a Young Modulus greater than the one of the heavy material. Thus, the outer annular belt 912 retains and maintains the annular disk 910 during the rotation, thereby minimizing deformations of the annular disk 910. Therefore, the high energy density flywheel comprising the first member and the second member may be operated at a higher rotational speed than a typical heavy flywheel not provided with a second member.

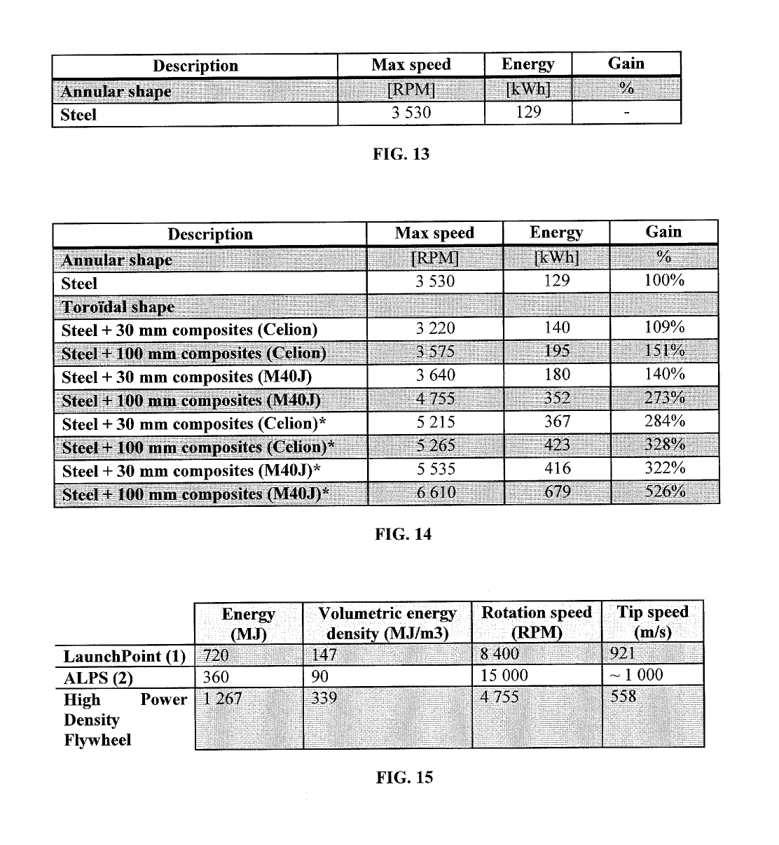

FIG. 12 shows the mechanical characteristics of a first material and a second material used. In the exemplary embodiment, the first material comprises steel 4340 while the second material comprises a composite material named M40J. FIG. 13 shows that a maximal rotational speed of 3530 rpm may be attained with the illustrated configuration. Such a configuration may provide 129 kWh.

Although minimization of the deformations of the first material with the second material may be achieved thanks to the annular belt configuration described above, the arrow 914 in FIG. 9A shows the deformations that may nevertheless occur when the flywheel rotates at a high rotational speed.

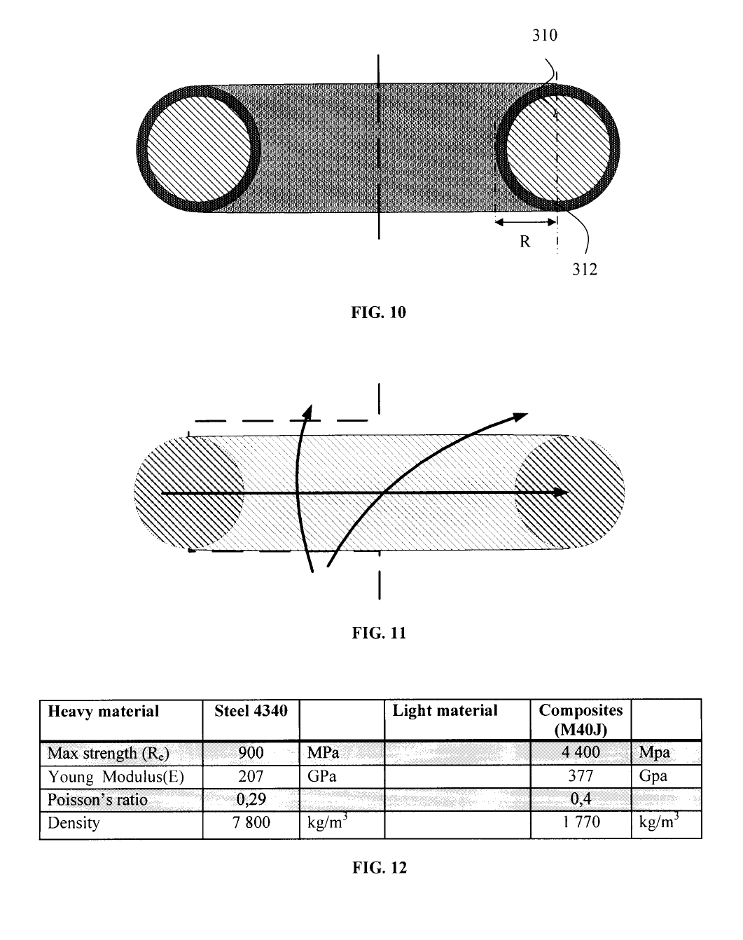

In order to further minimize deformation of the first material, a toroidal configuration as illustrated in FIG. 10 may be used. As illustrated, the first member 310 has a toroidal shape and the second member 312 has an empty toroidal shape wholly enclosing the first member 310.

In one embodiment, the second member comprises at least three covers or layers, each being wound on the first member 310. These covers or layers may comprise composite sheets or composite fibers wound with a synthetic resin, as known in the art.

In a further embodiment, each of the three covers is wound on the first member 310 according to a respective principal direction thereof, as shown in FIG. 11. In other words, a first one of the three covers is axially wound on the first member, a second one of the three covers is circumferentially wound on the first member and a third one of the three covers is wound at 45 degrees with respect to the first one of the three covers. The skilled addressee will appreciate that winding techniques typically used in the art of winding material may be adapted to the composite material used therein. The skilled addressee will also appreciate that various other arrangements may be used to provide a toroidal flywheel as described above.

Referring now to FIG. 10 and also to FIG. 14, theoretical results will be presented for an embodiment of a high energy density flywheel as illustrated in FIG. 10, that is a toroidal high energy density flywheel. The first member has an inner diameter of 1.66 meter and a radius of 0.3 meter. The skilled addressee will appreciate that the thickness of the second member may be varied.

The second member which is made of a composite material and totally encloses the first member retains and maintains the first member during the rotation in each direction, thereby minimizing even more deformations of the first material. Thus, the high energy density flywheel may be operated at a higher rotational speed than a typical heavy flywheel not equipped with a second member. It may also be operated at a higher rotational speed than the rotational speed allowed with the annular configuration presented above with reference to FIG. 9A and 9B.

FIG. 14 shows the maximal rotational speed that may be attained with various configurations of a toroidal high energy density flywheel as shown in FIG. 10. The four last results, i.e. those presented with an asterisk, have been obtained using the maximal yield strength of the second material, while the other results have been obtained using the maximal yield strength of the first material for obtaining the maximal allowed rotational speed. The results show that for most of the configurations, a higher rotational speed than the one obtained with the annular configuration may be obtained. The skilled addressee will appreciate that the quantity of energy that may be store in the high energy density flywheel may be greatly improved with the toroidal configuration using the first material and the second material The column of the right of the table shows in percent, the gain that may be attained with respect to the annular configuration discussed above.

The skilled addressee will appreciate that the toroidal configuration of a high energy density flywheel presented above is of great advantage since it enables to store a greater quantity of energy with respect to the configuration of the prior art, while using a lower rotational speed. The lower rotational speed further enables to minimize the aerodynamics losses and the losses due to the bearings, thereby enabling a longer storage of the energy.

FIG. 15 shows technical characteristics for various types of flywheel. The two first types presented are composite flywheels of the art respectively proposed by the company LaunchPoint and the research group ALPS while the third one is a toroidal high energy density flywheel using a first material and a second material The composite flywheels should be operated at a high rotational speed since their mass is low. At a high rotational speed, the speed at the tip is also high, thus causing aerodynamics losses.

FIG. 15 clearly shows that the use of a toroidal high energy density flywheel using a first material and a second material is of great advantage. Indeed, the flywheel has a high energy density 2.3 higher in the example presented above than the conventional flywheels, while rotating at a lower rotational speed, thereby storing the energy on a longer period of time since the losses are reduced.

From the above, the skilled addressee will appreciate that a high energy density flywheel as described therein enables to store a great quantity of kinetic energy while minimizing the energetic losses therein. The skilled addressee will also appreciate that, since the speed of rotation of the flywheel and the mass thereof are relatively high, the storage duration of the stored kinetic energy is also improved, thanks to the inertia of the flywheel.

From the above, the skilled addressee will appreciate that the high energy density flywheel as described above, even if adapted for short term applications, may be particularly useful for medium and long term applications where energy has to be stored for several hours and even over a 24 hours period.

According to another aspect, the high energy density flywheel as previously defined may be used in combination with a motor-generator for enabling a bidirectional conversion of the kinetic energy into electric energy and vice versa.

According to still another aspect, the high energy density flywheel as previously defined may be used in combination with an electrical network for stabilizing fluctuation of the network via power conversion systems.

According to yet another aspect, the high energy density flywheel as previously defined may be used in combination with a flywheel energy storage system to restitute high energy on a short period of time, such, as a non limitative example, for fast recharge of electrical batteries. Such a fast recharge may be of particular importance for recharging electrical vehicles in a given very short period of time. In a further embodiment, the given period of time may range from 1 minute to 10 minutes although other embodiments may be considered.

According to another aspect, there is also provided a flywheel energy storage system using a high energy density flywheel as described above.

As previously mentioned, the skilled addressee will appreciate that such an energy storage system may be particularly useful in charging infrastructure for electric vehicles or plug-in hybrid electric vehicles at a constant rate, which is of great advantage.

Moreover, the energy storage system may also be of particular interest in applications where a great quantity of energy is requested over a brief period of time, such as the ultra fast charging of electrical vehicles in few minutes. Indeed, the energy storage system may provide the requested quantity of energy over a brief period of time without unbalancing the electrical distribution network.

The skilled addressee will appreciate that the energy storage system may also be useful to stabilize fluctuations of an electrical network, to support the electric grid for load leveling, peak shaving, voltage and frequency regulation, renewable energy integration and for other applications where constant or variable power is necessary.

The skilled addressee will also appreciate that the energy storage system may be used to provide energy storing units distributed over the whole electrical distribution network. Indeed, the energy storage system may be installed in any area, including urban areas wherein it may be desirable to maintain an energy storing capacity.

The skilled addressee will also appreciate that the energy storage system may also be useful to provide a reliable UPS (Uninterruptible Power Supply). Indeed, contrary to the batteries based UPS, a UPS storing energy in a flywheel may be more reliable and have a long service life, which is of great advantage.

It should also be mentioned that an energy storing system using a flywheel as a reservoir of energy may be less expensive to maintain over a long term period. Indeed, while batteries based systems must be periodically checked since the batteries typically have to be replaced every two to four years at least, the flywheel may store and retrieve energy over 20 years, without any need to replace the flywheel. Thus, although the energy storage system may be more expensive to implement, it may be less expensive over the time since the maintenance costs are greatly reduced.

The skilled addressee will also appreciate that such an energy storage system may be of particular interest for implementing a method for storing energy and restoring such energy upon request. Indeed, the system may be used to store available energy during the off-hours peak periods and to restitute the stored energy during the peak periods. With this method, the overall energy production may be more efficiently used, which is of great advantage. Moreover, the method may also help reducing the number Of power plants that may be needed just to respond to the peak periods, which is also of great advantage.

In the illustrating drawings and throughout the present description, the flywheel has been described as being adapted to be mounted on a rotating shaft but the skilled addressee will appreciate that other arrangements may be considered. For example, the flywheel may be hold by levitation thanks to magnetic supports. Moreover, the flywheel may be mounted in the horizontal direction as shown in FIG. 1 as well in the vertical direction.

Although the above description relates to specific preferred embodiments as presently contemplated by the inventors, it will be understood that the invention in its broad aspect includes mechanical and functional equivalents of the elements described herein and is not limited to particular applications described therein.

1-32. (canceled)

33. A high energy density flywheel having a central rotating axle for storing kinetic energy, said high energy density flywheel comprising:
a first member to be operatively mounted around the central rotating axle, said first member comprising a first material having a given high mass density enabling a given high kinetic energy storage capacity; and
a second member operatively attached to the first member, said second member surrounding an outside portion of said first member subject to radial forces generated by a rotation of said flywheel, said second member comprising a second material having a given high yield strength enabling a given high maximum rotational speed;
wherein the second member enables an operation of the high energy density flywheel at a given high flywheel rotational speed, to thereby provide the flywheel with a given high kinetic energy storage capacity.

34. The high energy density flywheel according to claim 33, wherein the flywheel is adapted to be mountable on a rotating shaft.

35. The high energy density flywheel according to claim 33, further comprising a magnetic coupling element mounted on an inner side thereof and adapted for interacting with an associated magnetic driving element mountable proximate the central rotating axle.

36. The high energy density flywheel according to claim 34, further comprising an inner hub fixedly mounted to the rotating shaft via a first coupling and a second coupling mounted on both sides of the inner hub.

37. The high energy density flywheel according to claim 33, wherein the first member has a crown shape and is made of a single piece.

38. The high energy density flywheel according to claim 33, wherein the first material is selected from a group consisting of steel, lead, tungsten and a combination thereof.

39. The high energy density flywheel according to claim 33, wherein the second material is selected from a group consisting of carbon, Kevlar™ and a combination thereof.

40. The high energy density flywheel according to claim 33, wherein the second material comprises a composite material.

41. The high energy density flywheel according to claim 33, further comprising attaching means for attaching the first member and the second member together.

42. The high energy density flywheel according to claim 41, wherein the attaching means comprise glue.

43. The high energy density flywheel according to claim 33, wherein the second member wholly encloses the first member.

44. The high energy density flywheel according to claim 33, wherein the second member is belt shaped and extends on a radial outside portion of the first member.

45. The high energy density flywheel according to claim 33, wherein the first member comprises a plurality of sub-elements, each being enclosed in the second member.

46. The high energy density flywheel according to claim 33, wherein the first member has a toroidal shape.

47. The high energy density flywheel according to claim 46, wherein the second member has an empty toroidal shape wholly enclosing the first member.

48. The high energy density flywheel according to claim 47, wherein the second member comprises at least three covers, each being wound on the first member.

49. The high energy density flywheel according to claim 48, wherein each of the three covers is wound on the first member according to a respective principal direction thereof.

50. The high energy density flywheel according to claim 48, wherein a first one of the three covers is axially wound on the first member, a second one of the three covers is circumferentially wound on the first member and a third one of the three covers is wound at 45 degrees with respect to the first one of the three covers.

51. Use of the high energy density flywheel as defined in claim 33, for storing said kinetic energy over a 24 hours period.

52. Use of the high energy density flywheel as defined in claim 33, for recharging an electrical battery in a given period of time.
